(19) United States
(12) Patent Application Publication
(10) Pub. No.: US 2008/0181995 A1
(43) Pub. Date: Jul. 31, 2008

(54) METHOD OF FRYING AND DRYING SLICED VEGETABLES

(75) Inventor: Kraig Rawls, Madera, CA (US)

Correspondence Address: MYERS DAWES ANDRAS & SHERMAN, LLP, 19900 MACARTHUR BLVD., SUITE 1150, IRVINE, CA, 92612, US

(73) Assignee: Warnock Food Products, Inc., Madera, CA (US)

(21) Appl. No.: 11/743,872

(22) Filed: May 3, 2007

Related U.S. Application Data
(60) Provisional application No. 60/887,599, filed on Jan. 31, 2007.

(51) Int. Cl. A23L 1/212; A23L 1/217

(52) U.S. Cl. 426/295; 426/296

(57) ABSTRACT

The disclosed method relates to processing high moisture content vegetables, such as onions. The method involves slicing the onions, applying a dry coating to the sliced onions without using a moisture-based batter, frying the dry coated onions to a moisture percentage of about 8%, and then drying the fried onions to a moisture percentage of 1% to 1-2% The slicing step is ideally accomplished with a corrugated blade in order to provide each onion slice with an enhanced surface area for enhanced retention of a dry coating, and for shortening the frying and drying time even more than is possible by eliminating the use of a moisture-based batter.

### RELATED APPLICATIONS

This application relates to and claims priority pursuant to 35 U.S.C. §119(e) from U.S. Provisional Application Ser. No. 60/887,599, filed on Jan. 31, 2007, entitled “IMPROVIED METHOD OF FRYING AND DRYING SLICED VEGETABLES.” The benefits of priority from this application, including the filing date of Jan. 31, 2007, is hereby claimed, and its disclosure is hereby incorporated by reference as if fully set forth herein.

### BACKGROUND OF THE INVENTION

1. Field of the Invention

The present invention pertains generally to method of producing prepared food products and, more particularly, to an improved method of frying and drying sliced vegetables.

2. Description of the Prior Art

When processing slices derived from high moisture content vegetables, it is often necessary to dry the vegetable slices after frying them because the vegetable slices cannot be fried down to the desired moisture content by frying alone without burning. This has led to processing by both frying and drying to get the fried vegetable slices down to the moisture content that provides the desired crunch or mouth feel.

It is believed that the known methods require extensively long periods of drying time because they use conventional moisture-based coatings that add moisture in the first place, and that when fried, tend to seal in the vegetable's natural moisture.

With some vegetables slices, such as onions slices, the required drying period is measured in hours rather than minutes. With onions, in particular, if the onion slices are battered with a moisture-based coating, it takes about four hours to dry the onions to about 1% moisture content. A lengthy drying period requires drying systems with correspondingly long travel times, or relatively inefficient, slow, batch processing.

There remains a need, therefore, for an improved process of frying and drying sliced vegetable that reduces the required drying time to get to the desired moisture percentage.

### BRIEF SUMMARY OF THE INVENTION

The present invention specifically addresses and alleviates the above mentioned deficiencies associated with the prior art. More particularly, the present invention, in a preferred embodiment is, a

While the apparatus and method has or will be described for the sake of grammatical fluidity with functional explanations, it is to be expressly understood that the claims, unless expressly formulated under 35 USC §112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC §112 are to be accorded full statutory equivalents under 35 USC §112. The invention can be better visualized by turning now to the following drawings wherein like elements are referenced by like numerals.

In one aspect, the invention may be regarded as a method of preparing fried and dried vegetable slices from high moisture content vegetables, with a shortened drying time that is measured in minutes rather than hours, comprising the steps of: slicing a plurality of high moisture content vegetables with a corrugated blade to produce crinkle cut vegetable slices with nooks and crannies that provide an enhanced holding effect for retaining a dry coating and an increased surface area for moisture reduction; coating the crinkle cut vegetable slices with substantially dry coating to produce dry coated vegetable slices shaking the dry coated vegetables to remove loose dry coating to preserve oil during frying and minimize clumping; frying the dry coated vegetable slices to produce fried vegetable slices with a moisture content reduced to a first percentage; cooling the fried vegetable slices; and drying the fried vegetable slices on a continuously moving conveyor for a short period of time to produce fried and dried onion slices with a moisture content reduced to a second lower percentage.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flow chart showing a process for frying and drying high-moisture vegetables according to a preferred embodiment of the invention;

FIG. 2 is a schematic diagram showing the process of frying and drying high-moisture vegetables of FIG. 1, as implemented in a preferred production line for onions; and

FIG. 3 is a perspective view of a crinkle cut onion slice 200 that has an enhanced surface area for enhanced retention of a dry coating, and for being efficiently fried and dried in a shortened period of time, as produced with a corrugated blade according to a preferred embodiment of the invention.

### DETAILED DESCRIPTION OF THE PREFERRED EMBODIMENTS

The present invention relates a novel and high-throughput method of slicing, frying and then drying high moisture content vegetables including, in particular, onions which offer certain challenges. The method, however, can also be used with other high moisture content vegetables such as carrots, turnips, squash, garlic, potatoes, sweet potatoes, yams, zucchini, okra, mushrooms, asparagus, green beans, celery, and broccoli.

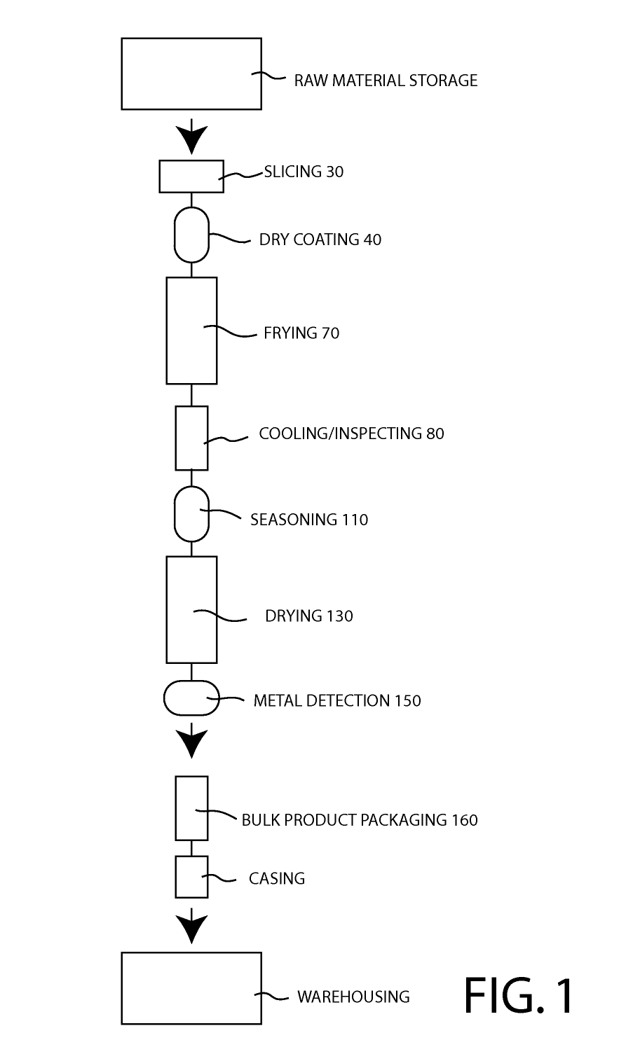

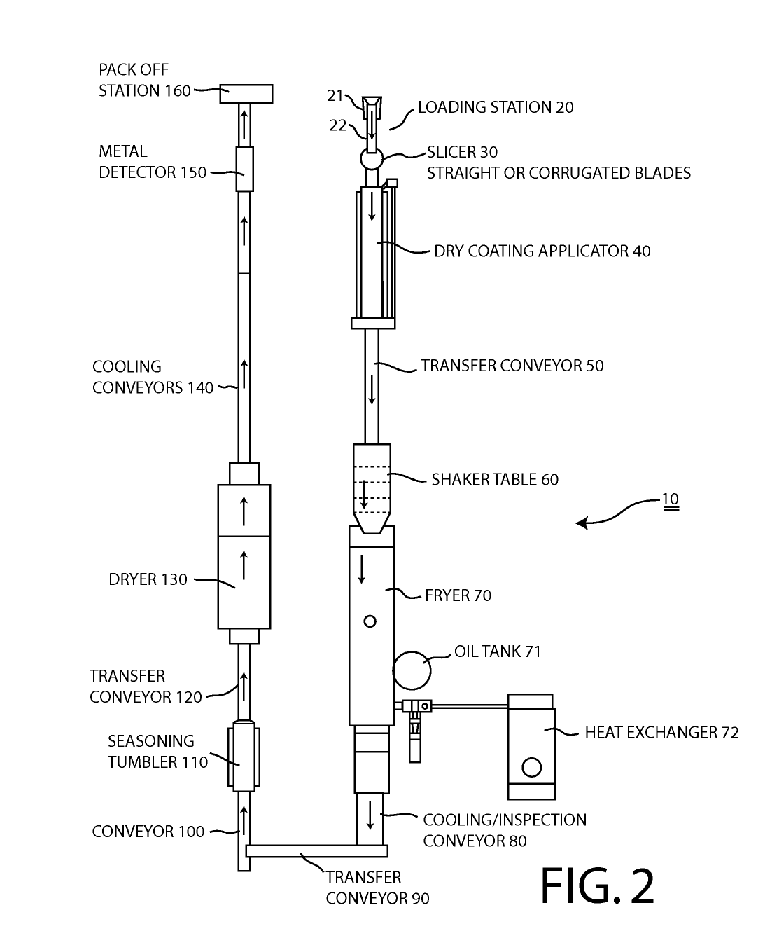

FIGS. 1 and 2 can be reviewed together. FIG. 1 depicts a schematic flow diagram of a preferred embodiment of a process for frying and drying vegetable slices. FIG. 2 depicts a schematic diagram of a production line 10 for frying and drying sliced onions according to a preferred embodiment of the present invention is generally designated 10. As shown, the processing line 10 begins with a loading station 20 having a hopper 21 and related elevator 22. At this station 20, workers take fresh onions that have been topped, bottomed and peeled, and transfer them by hand into the hopper 21 where they are picked up by the slats of the elevator 22 and carried upward for delivery to the slicer 30. At this point, the fresh onions have a moisture content of 88% to 92% moisture.

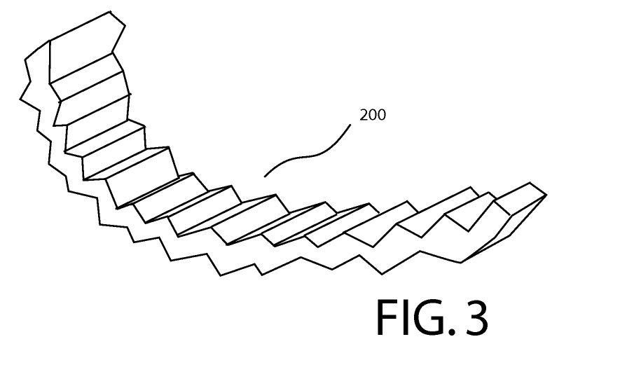

The preferred slicer 30 is an inertial slicer manufactured by Urshel. In operation, as onions fall into the slicer 30, and a rotary mechanism or spinner in the middle of the slicer 30 centrifugally spins or presses the onions against a circular array of surrounding blades that cut the onions into slices. The plurality of blades can be straight blades or, as is explained further below and as shown in FIG. 3, corrugated blades that uniquely provide the slices 200 with a crinkle cut profile that enhances retention of a dry coating and enhances the rapidity of drying subsequent to frying. In this particular embodiment, the onion slices fall downward from a chute at the bottom of the slicer 30.

The next station includes a dry flour applicator 40. The preferred flour applicator includes a tumbler and an auger for continuously feeding dry flour into the tumbler in parallel with the onion slices. The onion slices tumble around in the tumbler, along with the flour, and ultimately exit the far side of the flour applicator where they fall onto a transfer conveyor 50.

The transfer conveyor 50 is an inclined conveyor of well-known construction. The conveyor 50 transports the floured onion slices to a shaker table 60.

The preferred shaker table 60 is a vibratory conveyor that uses perforated screens that the flour can fall through. The shaker table 60 will remove the excess flour, smooth out the product flow, and spread out the product, all in order to reduce clumping and balling up within the fryer, and to use the oil in the fryer more efficiently by not adding unnecessary flour. The shaker table 60 is a commercially available vibratory conveyor, but it has been modified to include transverse rods that are spaced along the path of the floured onion slices (as suggested by the dashed lines). The transverse rods slow down the motion of the floured onion slices to help shake excess flour from their surface, and to help spread out the floured onion pieces before they enter the fryer 70.

The fryer 70 is used to fry the floured onion pieces down and lower their moisture content. With onions, as with other high moisture content vegetables, it is not practical to fry the product all the way down without burning the exterior of the product. For this reason, the fryer 70 generally reduce the moisture content of the floured onion slices down to a moisture content of about 8%.

The preferred fryer 70 is a conventional fryer that was manufactured by Heat & Control. It is a single pass fryer with a wire mesh conveyor. As shown in FIG. 1, the fryer 70 works with an oil tank 71 and a gas fired heat exchanger 72. As oil leaves with the fried product, it is sometimes necessary to replenish the oil supply.

At the discharge end of the fryer 70, the fried onion slices drop from the fryer 70 onto a cooling/inspection conveyor 80. Here, workers are given an opportunity to visually examine the fried product, and to quantitatively measure moisture content with suitable instruments, and thereby make adjustments to flow rate, temperature, etc., in order to achieve the desired results.

In the illustrated embodiment, the fried onion slices are further conveyed on a right angle transfer conveyor 90 that is located at right angles relative to the cooling/inspection conveyor 80. While a straight line arrangement or other layout is possible, the right angle transfer conveyor 90 permits the overall production line 10 to be arranged in a compact U-shaped manner as shown.

A feed conveyor 100 takes product moving on the transfer conveyor 90 and moves it into the load end of a seasoning tumbler 110.

The preferred seasoning tumbler 110 contains a rotating barrel and applies salt and other desired seasonings via a feed auger that continuously feeds the salt into the tumbler in parallel with the fried onion pieces.

Another conveyor 120 is located at the discharge end of the seasoning tumbler 110 in order to further transport the fried and seasoned onion pieces to a dryer 130.

The preferred dryer 130 is a multi-pass dryer that operates at about 200-300 degrees (the presently preferred drying temperature is about 280-285 degrees) and that contains multiple back and forth conveyor belts to provide an overall dwell time of about only about twelve to twenty minutes. The dryer 130 reduce the moisture content of the fried and seasoned onion slices to about 1% to 2%. In prior known processes, this drying step took as long as four hours because of the high moisture content of the fresh onion slices, and because that moisture was effectively trapped inside of the fried onion slices by the moisture-based batter. Here, however, because the onion slices were dry-coated or floured without use of a moisture-based batter, more moisture can be removed by the fryer 70 before the color is too deep or the product is burned, and the remaining moisture can be rapidly dried out of the fried onion slices within the dryer 130.

Also, when the slicer 30 is outfitted with corrugated blades rather than straight blades, then the resulting crinkle cut slices 200 provide nooks and crannies to help hold the dry flour applied within the applicator 40, and provide even more surface area to remove moisture content within the fryer 70 and the dryer 130 (see FIG. 3).

After leaving the dryer 130, the fried and dried onion slices are deposited on a cooling conveyor 140. After that, the fried and dried onion slices pass through a metal detector 150 that is used to look for metal that may have inadvertently made its way into the product stream. An example of such undesired metal is a portion of a mesh conveyor link that rubbed off due to friction

The final station is a pack off station 160. Here, the finished product is put into bulk packaged for further packaging at another location or, if desired, is put directly into retail packages.

While the particular process that is shown and disclosed in detail is fully capable of obtaining the objects and providing the advantages herein before stated, it is to be understood that it merely illustrates the presently preferred embodiment of the invention and that no limitations are intended to be confined to the details of the preferred equipment or illustrated process shown and described herein, other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A method of preparing fried and dried vegetable slices from high moisture content vegetables, with a shortened drying time that is measured in minutes rather than hours, comprising the steps of:
slicing a plurality of high moisture content vegetables with a corrugated blade to produce crinkle cut vegetable slices with nooks and crannies that provide an enhanced holding effect for retaining a dry coating and an increased surface area for moisture reduction;
coating the crinkle cut vegetable slices with substantially dry coating to produce dry coated vegetable slices
shaking the dry coated vegetables to remove loose dry coating to preserve oil during frying and minimize clumping;
frying the dry coated vegetable slices to produce fried vegetable slices with a moisture content reduced to a first percentage;
cooling the fried vegetable slices; and
drying the fried vegetable slices on a continuously moving conveyor for a short period of time to produce fried and dried onion slices with a moisture content reduced to a second lower percentage.

2. The method of claim 1 wherein the high moisture content vegetables are onions.

3. The method of claim 1 wherein the high moisture content vegetables are selected from the group comprising onions, carrots, turnips, squash, garlic, potatoes, sweet potatoes, yams, zucchini, okra, mushrooms, asparagus, green beans, celery, and broccoli.

4. The method of claim 1 comprising the further steps of tumbling the fried vegetable slices before drying them.

5. The method of claim 4 comprising the further step of applying a seasoning to the fried vegetable slices before drying them.

6. The method of claim 5 wherein the step of applying the seasoning is accomplished during the tumbling step.

7. The method of claim 1 wherein the dry coating comprises one of a wheat flour, a corn flour and a multi-grain flour.

8. The method of claim 7 wherein the step of coating the vegetable slices with a dry coating is accomplished in a tumbler.

9. The method of claim 1 wherein the slicing step is accomplished with an inertial slicer having a plurality of blades and a rotary mechanism for spinning the vegetables into the plurality of blades.

10. The method of claim 1 wherein the first percentage that frying step reduces the moisture content of the vegetables slices to is from 8% to 12%.

11. The method of claim 1 wherein the second percentage that the drying step reduces the moisture content of the fried vegetable slices to is from 1% to 1-2%.

12. A method of preparing fried and dried vegetable slices from high moisture content vegetables, with a shortened drying time that is measured in minutes rather than hours, comprising the steps of:
slicing a plurality of high moisture content vegetables with a blade to produce cut vegetable slices;
coating the cut vegetable slices with substantially dry coating to produce dry coated vegetable slices
shaking the dry coated vegetables to remove loose dry coating to preserve oil during frying and minimize clumping;
frying the dry coated vegetable slices to produce fried vegetable slices with a moisture content reduced to a first percentage;
cooling the fried vegetable slices; and
drying the fried vegetable slices on a continuously moving conveyor for a short period of time to produce fried and dried onion slices with a moisture content reduced to a second lower percentage.

13. The method of claim 12 wherein the high moisture content vegetables are onions.

14. The method of claim 12 wherein the high moisture content vegetables are selected from the group comprising onions, carrots, turnips, squash, garlic, potatoes, sweet potatoes, yams, zucchini, okra, mushrooms, asparagus, green beans, celery, and broccoli.

15. The method of claim 12 comprising the further steps of tumbling the fried vegetable slices before drying them.

16. The method of claim 15 comprising the further step of applying a seasoning to the fried vegetable slices before drying them.

17. The method of claim 16 wherein the step of applying the seasoning is accomplished during the tumbling step.

18. The method of claim 12 wherein the dry coating comprises one of a wheat flour, a corn flour and a multi-grain flour.

19. The method of claim 18 wherein the step of coating the vegetable slices with a dry coating is accomplished in a tumbler.

20. The method of claim 12 wherein the slicing step is accomplished with an inertial slicer having a plurality of blades and a rotary mechanism for spinning the vegetables into the plurality of blades.

21. The method of claim 20 wherein the blades are straight-cut blades.

22. The method of claim 20 wherein the blades are corrugated blades that produce cut vegetable slides with nooks and crannies that provide an enhanced holding effect for the dry coating and an increased surface area for faster moisture reduction both during and subsequent to frying.

23. The method of claim 12 wherein the first percentage that frying step reduces the moisture content of the vegetables slices to is from 8% to 12%.

24. The method of claim 12 wherein the second percentage that the drying step reduces the moisture content of the fried vegetable slices to is from 1% to 1-2%.
